(19) United States
(12) Patent Application Publication
(10) Pub. No.: US 2026/0179554 A1
(43) Pub. Date: Jun. 25, 2026

(54) DISPLAY PANEL AND DISPLAY DEVICE

(71) Applicants: Wuhan Tianma MicroElectronics Co., Ltd. Shanghai Branch., Shanghai (CN); Wuhan Tianma Micro-Electronics Co., Ltd., Wuhan (CN)

(72) Inventors: Mengmeng ZHANG, Shanghai (CN); Yuantao Wu, Shanghai (CN)

(21) Appl. No.: 19/407,413

(22) Filed: Dec. 3, 2025

(30) Foreign Application Priority Data
Dec. 19, 2024 (CN) 202411884817.X

(51) Int. Cl. G09G 3/3233

(52) U.S. Cl. CPC G09G 3/3233; G09G 2300/0842; G09G 2300/0861; G09G 2310/08; G09G 2320/0247

(57) ABSTRACT

Display panel and display device are provided. Working stages of the display panel include a plurality of non-light-emitting stages and a plurality of light-emitting stages. At least part of a non-light-emitting stage of the plurality of non-light-emitting stages includes a data writing stage. The display panel includes a plurality of sub-pixels. A sub-pixel of the plurality of sub-pixels includes a pixel circuit and a light-emitting element electrically connected to the pixel circuit. The light-emitting element emits light during a light-emitting stage. The pixel circuit includes a driving transistor and a data writing transistor. The data writing transistor provides a data signal to the driving transistor during the data writing stage. In the display panel, a display process of one frame includes a plurality of subframes including a data writing frame and at least one holding frame.

### CROSS-REFERENCE TO RELATED APPLICATION

This application claims priority of Chinese Patent Application No. :202411884817X, filed on December 19, 2024, the entire contents of which are hereby incorporated by reference.

### FIELD OF THE DISCLOSURE

The present disclosure generally relates to the field of display technology and, more particularly, relates to a display panel and a display device.

### BACKGROUND

In an organic light-emitting diode (OLED) display panel, each pixel includes a pixel circuit and a light-emitting element. The pixel circuit controls a current to flow through the light-emitting element, thereby driving the light-emitting element to emit light. By controlling a switching state of a transistor in a pixel circuit and a data signal written to the pixel circuit, a light-emitting duration of a light-emitting element and a size of a current flowing through the light-emitting element can be adjusted, thereby adjusting brightness of each pixel to form a display image. A design of pixel circuits enables the display panel to achieve high-resolution, high-contrast and fast-response in image display.

The pixel circuit may experience signal fluctuations during operation. The signal fluctuations are transmitted to the light-emitting element and result in variations in brightness of the light-emitting element, leading to a flickering effect visible to the human eye on the display panel.

### BRIEF SUMMARY OF THE DISCLOSURE

One aspect of the present disclosure provides a display panel. Working stages of the display panel include a plurality of non-light-emitting stages and a plurality of light-emitting stages. At least part of a non-light-emitting stage of the plurality of non-light-emitting stages includes a data writing stage. The display panel includes a plurality of sub-pixels. A sub-pixel of the plurality of sub-pixels includes a pixel circuit and a light-emitting element electrically connected to the pixel circuit. The light-emitting element emits light during a light-emitting stage. The pixel circuit includes a driving transistor and a data writing transistor. The data writing transistor provides a data signal to the driving transistor during the data writing stage. In the display panel, a display process of one frame includes a plurality of subframes including a data writing frame and at least one holding frame. The light-emitting stage includes a first light-emitting stage in the data writing frame, a non-light-emitting stage adjacent to the first light-emitting stage and located before the first light-emitting stage includes the data writing stage. The light-emitting stage further includes at least one second light-emitting stage. A second light-emitting stage of the at least one second light-emitting stage is located in the data writing frame in which the first light-emitting stage is located and/or in a holding frame of the at least one holding frame adjacent to the data writing frame in which the first light-emitting stage is located. A light-emitting duration of the first light-emitting stage is different from a light-emitting duration of the second light-emitting stage.

Another aspect of the present disclosure provides a display device including a display panel. Working stages of the display panel include a plurality of non-light-emitting stages and a plurality of light-emitting stages. At least part of a non-light-emitting stage of the plurality of non-light-emitting stages includes a data writing stage. The display panel includes a plurality of sub-pixels. A sub-pixel of the plurality of sub-pixels includes a pixel circuit and a light-emitting element electrically connected to the pixel circuit. The light-emitting element emits light during a light-emitting stage. The pixel circuit includes a driving transistor and a data writing transistor. The data writing transistor provides a data signal to the driving transistor during the data writing stage. In the display panel, a display process of one frame includes a plurality of subframes including a data writing frame and at least one holding frame. The light-emitting stage includes a first light-emitting stage in the data writing frame, a non-light-emitting stage adjacent to the first light-emitting stage and located before the first light-emitting stage includes the data writing stage. The light-emitting stage further includes at least one second light-emitting stage. A second light-emitting stage of the at least one second light-emitting stage is located in the data writing frame in which the first light-emitting stage is located and/or in a holding frame of the at least one holding frame adjacent to the data writing frame in which the first light-emitting stage is located. A light-emitting duration of the first light-emitting stage is different from a light-emitting duration of the second light-emitting stage.

Other aspects of the present disclosure can be understood by a person skilled in the art in light of the description, the claims, and accompanying drawings of the present disclosure.

### BRIEF DESCRIPTION OF THE DRAWINGS

The accompanying drawings, which are incorporated in and constitute a part of the present specification, illustrate embodiments consistent with the disclosure and together with the description, serve to explain the principles of the present disclosure.

To more clearly illustrate the embodiments of the present disclosure or the technical solutions in the prior art, the accompanying drawings needed to be used in the description of the embodiments, or the prior art will be briefly introduced below. Obviously, for a person skilled in the art, other drawings can be obtained based on the accompanying drawings without creative efforts.

FIG. 1 illustrates a schematic diagram of a pixel circuit consistent with various embodiments of the present disclosure;

FIG. 2 illustrates a timing diagram of working stages of a display panel consistent with various embodiments of the present disclosure;

FIG. 3 illustrates a planar view of a display panel consistent with various embodiments of the present disclosure;

FIG. 4 illustrates a timing diagram of working stages of another display panel consistent with various embodiments of the present disclosure;

FIG. 5 illustrates a timing diagram of working stages of another display panel consistent with various embodiments of the present disclosure;

FIG. 6 illustrates a timing diagram of working stages of another display panel consistent with various embodiments of the present disclosure;

FIG. 7 illustrates a timing diagram of working stages of another display panel consistent with various embodiments of the present disclosure;

FIG. 8 illustrates a timing diagram of working stages of another display panel consistent with various embodiments of the present disclosure;

FIG. 9 illustrates a timing diagram of working stages of another display panel consistent with various embodiments of the present disclosure;

FIG. 10 illustrates a timing diagram of working stages of another display panel consistent with various embodiments of the present disclosure;

FIG. 11 illustrates a schematic diagram of another pixel circuit consistent with various embodiments of the present disclosure;

FIG. 12 illustrates a timing diagram of working stages of another display panel consistent with various embodiments of the present disclosure; and

FIG. 13 illustrates a planar view of a display device consistent with various embodiments of the present disclosure.

### DETAILED DESCRIPTION

To better understand the above objects, features, and advantages of the embodiments of the present disclosure, solutions of the embodiments in the present disclosure will be further described below. It should be noted that, in case of no conflict, the embodiments of the present disclosure and the features in the embodiments can be combined with each other.

Numerous specific details are set forth in the following description to provide a thorough understanding of the embodiments of the present disclosure. However, the embodiments of the present disclosure can also be implemented in ways different from those described herein. Obviously, the embodiments described herein are only some embodiments of the embodiments of the present disclosure, and do not represent all possible embodiments.

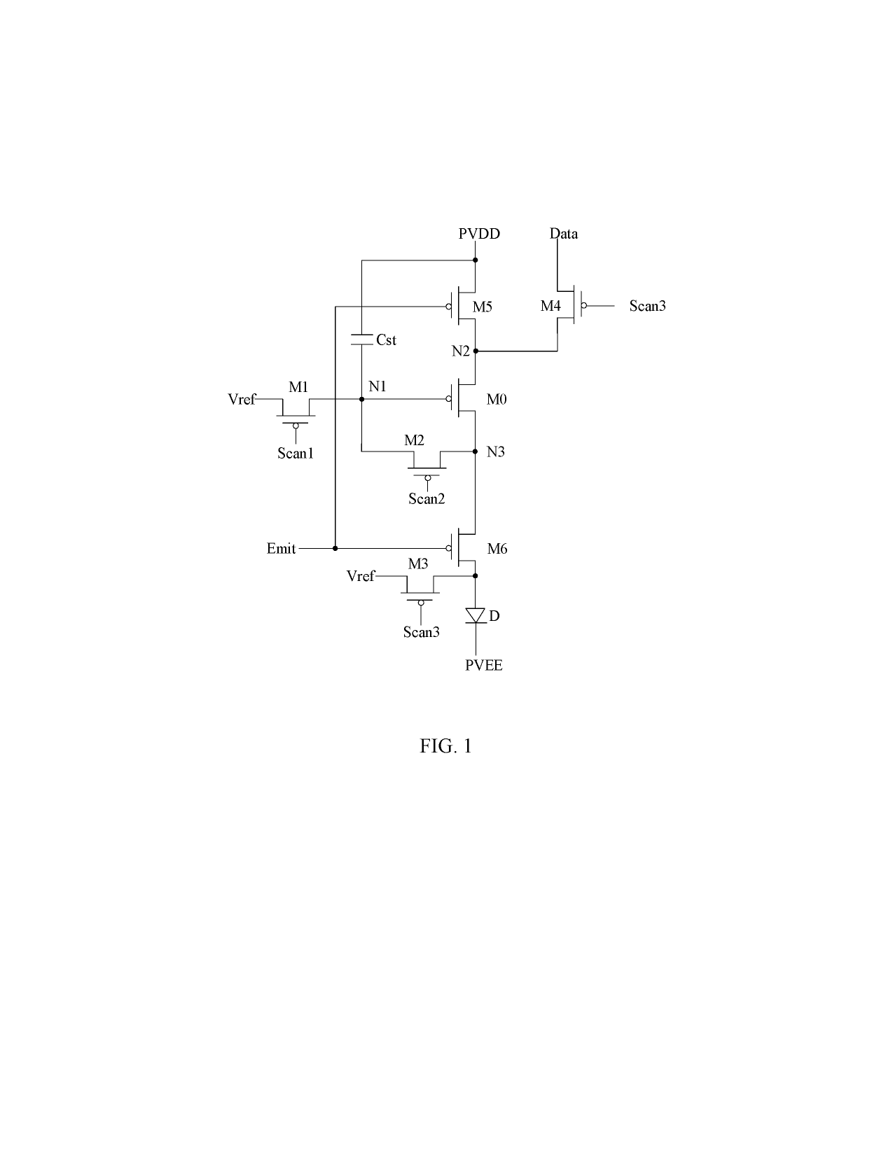

A pixel circuit provided in one embodiment is shown in FIG. 1 and includes a driving transistor (M0), a gate reset transistor (M1), a threshold compensation transistor (M2), an anode reset transistor (M3), a data writing transistor (M4), a first light-emission control transistor (M5), a second light-emission control transistor (M6) and a storage capacitor (Cst).

The gate reset transistor (M1) is configured to provide a reset signal (Verf) to a gate of the driving transistor (M0), the threshold compensation transistor (M2) is configured to provide a threshold compensation for the gate of the driving transistor (M0), the anode reset transistor (M3) is configured to provide a reset signal (Verf) to an anode of a light-emitting element (D), and the data write transistor (M4) is configured to provide a data signal (Data) to a first electrode of the driving transistor (M0). The first light-emitting control transistor M5 is configured to provide a power signal (PVDD) to the first electrode of the driving transistor (M0). The driving transistor (M0) is configured to provide a driving signal to the anode of the light-emitting element (D) according to the power signal (PVDD) and the data signal (Data). The second light-emitting control transistor (M6) is configured to provide a driving signal to the anode of the light-emitting element (D).

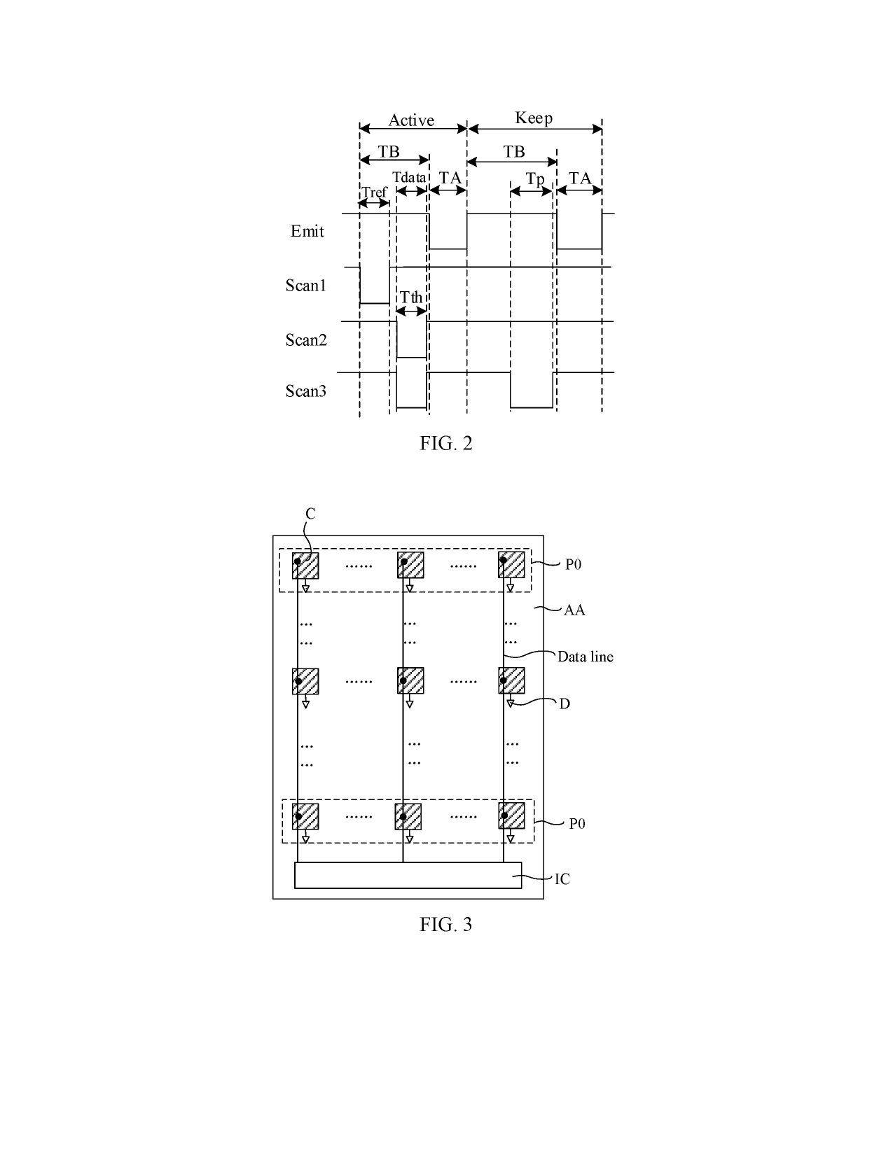

FIG. 2 illustrates a driving signal timing diagram of the pixel circuit shown in FIG. 1, that is, a timing diagram of working stages of the display panel. As shown in FIG. 2, the working stage of the display panel includes a plurality of non-light-emitting stages (TB) and a plurality of light-emitting stages (TA). Specifically, during a light-emitting stage (TA), the first light-emitting control transistor (M5) turns on and supplies a power signal (PVDD) to the first electrode of the driving transistor (M0), the driving transistor (M0) supplies a driving signal to the anode of the light-emitting element (D) according to the power signal (PVDD) and a data signal (Data). The second light-emitting control transistor (M6) turns on and supplies the driving signal to the anode of the light-emitting element (D), so that the light-emitting element emits light during the light-emitting stage (TA).

A display process for a frame includes a plurality of subframes. The plurality of subframes include a data writing frame (Active) and a holding frame (Keep). Both the data writing frame (Active) and the holding frame (Keep) include a non-light-emitting stage (TB) and a light-emitting stage (TA). The non-light-emitting stage (TB) in the data writing frame (Active) further includes a data writing stage (Tdata). The data writing transistor (M4) provides a data signal (Data) to the driving transistor (M0) during the data writing stage (Tdata).

FIG. 3 illustrates a planar view of a display panel consistent with various embodiments of the present disclosure. As shown in FIG. 3, the display panel includes a plurality of pixel circuits (C), and light-emitting elements (D) arranged in a display area (AA). A light-emitting element (D) is electrically connected to a pixel circuit (C). A specific circuit schematic diagram and a driving timing of the pixel circuit (C) can be referred to FIGS. 1 and 2. As shown in FIG. 3, the display panel also includes data signal lines (Data line). The plurality of pixel circuits (C) is connected to a same data signal line (Data line) and receives a data signal (Data) provided by a driver chip (IC) through the data signal line (Data line).

When displaying a frame, the brightness of each light-emitting element (D) in the display panel is different, and the data signal (Data) supplied to each light-emitting element (D) is also different. For the plurality of light-emitting elements (D) connected to the same data signal line (Data line) by the plurality of pixel circuits (C), the data signal (Data) supplied to one of the pixel circuits (C) is coupled with a node of another pixel circuit (C), thereby causing a potential of the node to fluctuate or even jump, leading to the brightness of the other light-emitting element (D) deviating from an expected value, and resulting in brightness fluctuations. Since the data signal (Data) is written during the data writing frame (Active), the above phenomenon causes the brightness of the light-emitting element (D) to fluctuate during the data writing frame (Active). The brightness of the data writing frame (Active) and the subsequent holding frame (Keep) becomes unbalanced, leading to visible brightness flickering on the display panel.

In view of the above, a display panel is provided in one embodiment, a planar structure of which is shown in FIG. 3. A circuit schematic diagram of a pixel circuit (C) in the display panel can be referred to FIG. 1. The display panel includes a plurality of sub-pixels. The sub-pixels include a pixel circuit (C), and a light-emitting element (D) electrically connected to the pixel circuit (C). The pixel circuit (C) includes a driving transistor (M0) and a data writing transistor (M4).

In one embodiment, working stages of the display panel includes a plurality of non-light-emitting stages (TB) and a plurality of light-emitting stages (TA). The light-emitting elements D emit light in a light-emitting stage TA. At least part of a non-light-emitting stage (TB) includes a data writing stage (Tdata). The data writing transistor M4 is configured to provide a data signal (Data) to the driving transistor (M0) during the data writing stage (Tdata).

Specifically, in the display panel, a display process of a frame includes a plurality of subframes including a data writing frame (Active) and at least one holding frame (Keep). The data writing stage (Tdata) occurs during the data writing frame (Active). The display panel does not perform data writing during the at least one holding frame (Keep) but instead uses the data signal written in the data writing frame (Active) to drive the luminous display.

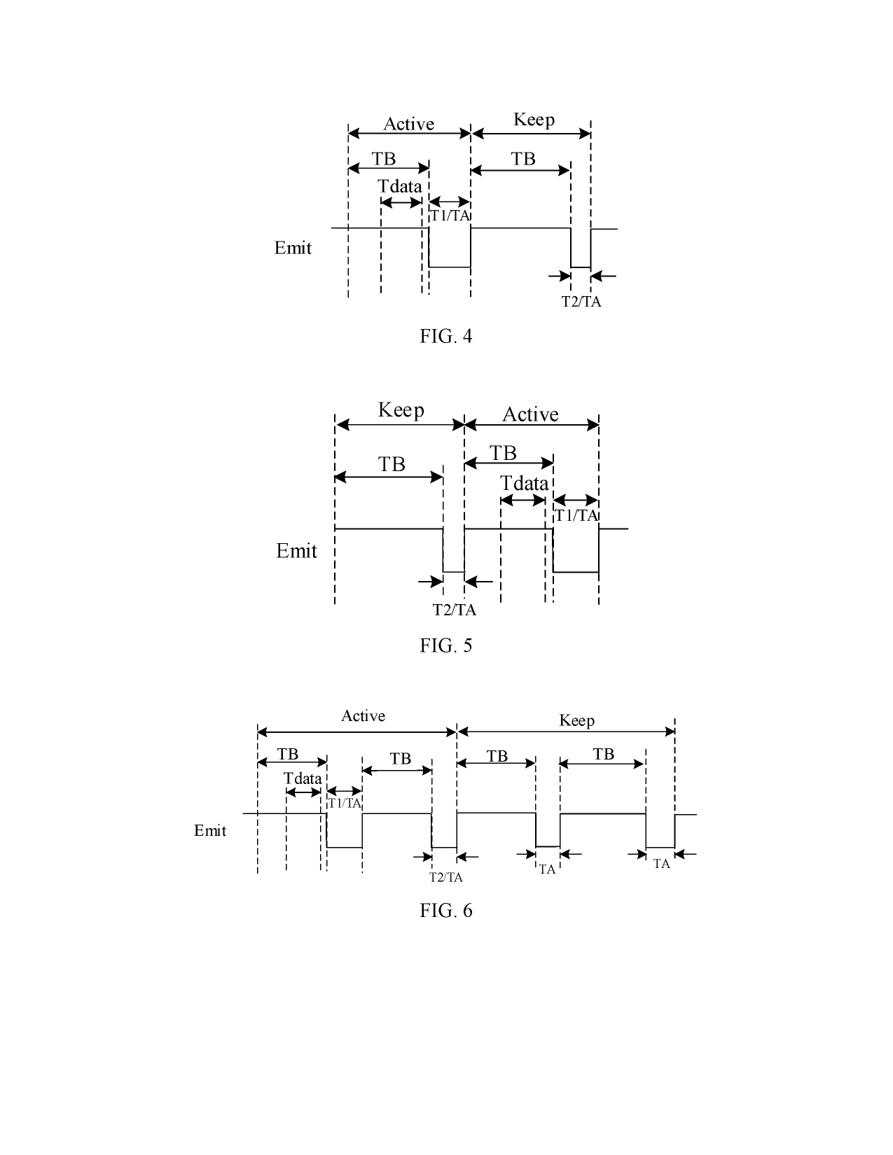

The light-emitting stage (TA) includes a first light-emitting stage (T1), which is in the data writing frame (Active). The non-light-emitting stage (TB) adjacent to the first light-emitting stage (T1) and located before the first light-emitting stage (T1) includes a data writing stage (Tdata). In one embodiment, as shown in FIGS. 4 and 5, each subframe only includes a non-light-emitting stage (TB) and a light-emitting stage (TA). The data writing stage (Tdata) is located in the non-light-emitting stage (TB) of the refresh frame (Active), and the first light-emitting stage (T1) is the light-emitting stage (TA) in the refresh frame (Active). In another embodiment, as shown in FIGS. 6 to 8, each subframe includes at least two non-light-emitting stages (TB) and at least two light-emitting stages (TA). The data writing stage (Tdata) occurs during the first non-light-emitting stage (TB) of the refresh frame (Active), while the first light-emitting stage (T1) occurs during the first light-emitting stage (TA) in the refresh frame (Active).

It can be understood that, in FIGS. 6 to 8, each subframe includes two non-light-emitting stages (TB) and two light-emitting stages (TA) as an example. Based on the present disclosure, a person skilled in the art can correspondingly implement embodiments including more non-light-emitting stages (TB) and light-emitting stages (TA), which will not be repeated herein.

As shown in FIGS. 4-8, the light-emitting stages (TA) also include at least one second light-emitting stage (T2) in the data writing frame (Activ)e where the first light-emitting stage (T1) is located, and/or the second light-emitting stage (T2) is in the holding frame (Keep) adjacent to the data writing frame (Active) where the first light-emitting stage (T1) is located. A light-emitting duration of the first light-emitting stage (T1) is different from a light-emitting duration of the second light-emitting stage (T2).

Specifically, in embodiments shown in FIGS. 4 and 5, each subframe only includes one non-light-emitting stage (TB) and one light-emitting stage (TA). The second light-emitting stage (T2) is in the holding frame (Keep) adjacent to the data writing frame (Active) where the first light-emitting stage (T1) is located. As shown in FIG. 4, the holding frame (Keep) may follow the data writing frame (Active), or as shown in FIG. 5, the holding frame (Keep) may precede the data writing frame (Active), corresponding to a last refreshed image.

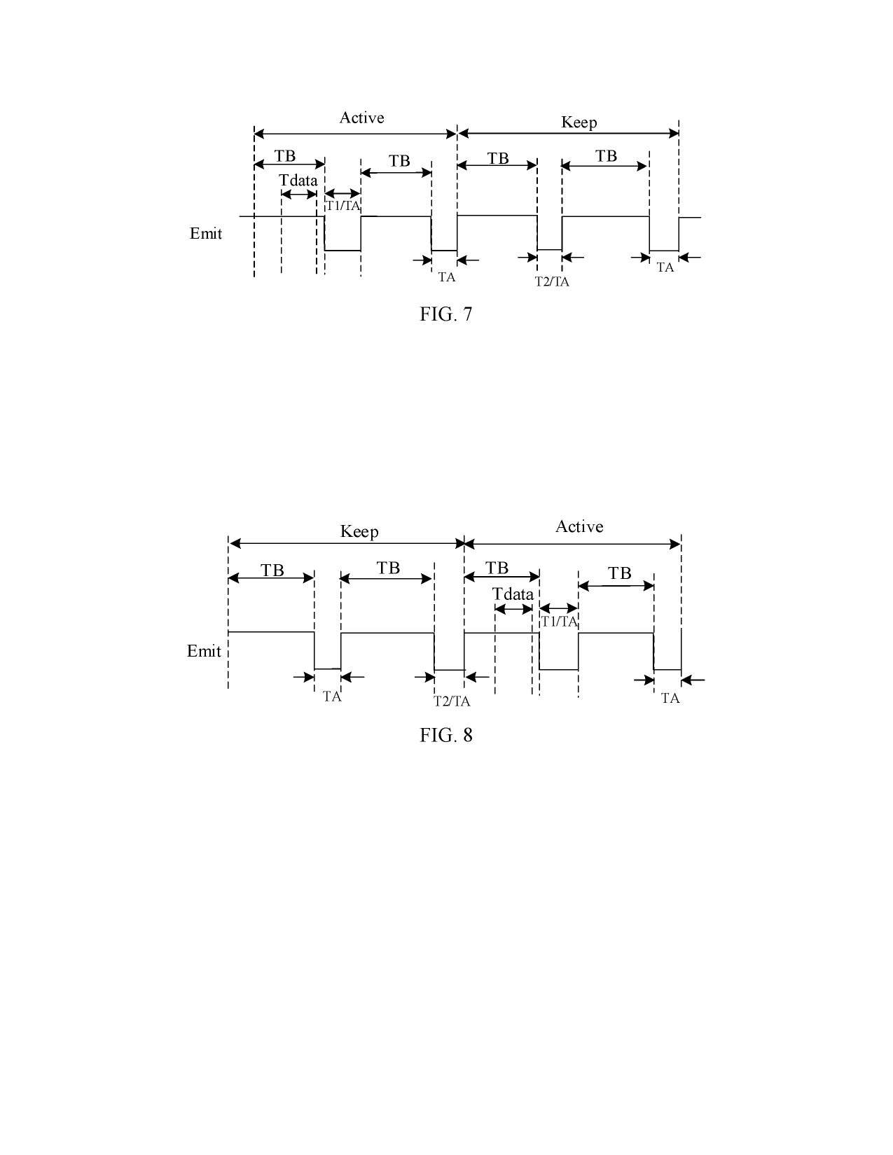

In embodiments shown in FIGS. 6-8, each subframe includes at least two non-light-emitting stages (TB) and at least two light-emitting stages (TA). As shown in FIG. 6, the second light-emitting stage (T2) can be in the data writing frame (Active) where the first light-emitting stage (T1) is located. As shown in FIG. 7, the second light-emitting stage (T2) can also be in the holding frame (Keep) adjacent to the data writing frame (Active) of the first light-emitting stage (T1) and can follow the data writing frame (Active). As shown in FIG. 8, the second light-emitting stage (T2) can also be in the holding frame (Keep) adjacent to the data writing frame (Active) where the first light-emitting stage (T1) is located and can precede the data writing frame (Active), corresponding to a previous data writing frame (Active).

Since the brightness of the light-emitting element (D) deviates from the expected value due to the writing of the data signal (Data), the resulting brightness fluctuation primarily occurs during the data writing stage (Tdata) of the data writing frame (Active). In related technologies, the plurality of light-emitting stages (TA) in the display panel has a same lighting duration. Since the brightness perceived by a human eye can accumulate over time, the brightness fluctuation will be noticeable, thereby affecting a display quality. In the above embodiments, the first light-emitting stage (T1) is a light-emitting stage adjacent to the data writing stage (Tdata), and the second light-emitting stage (T2) is located close to the first light-emitting stage (T1). By adaptively adjusting light-emitting durations of the first and second light-emitting stages, the brightness of the light-emitting element (D) perceived by the human eye during the data writing stage (Tdata) can be adjusted. Ultimately, the light-emitting duration of the first light-emitting stage (T1) differs from the light-emitting duration of the second light-emitting stage (T2).

In one embodiment, the brightness of the light-emitting element in the data writing frame (Active) can be adjusted by modifying its lighting duration within the data writing frame (Active). Alternatively, adjusting the lighting time of the light-emitting element in the holding frame (Keep) before and after the data writing frame (Active) can compensate for brightness fluctuations in the data writing frame (Active). The compensation mitigates the brightness variation caused by the data signal writing to the pixel circuit, thereby enhancing display quality.

Specifically, in the embodiment shown in FIGS. 6-8, each subframe includes at least two non-light-emitting stages (TB) and at least two light-emitting stages (TA). The pixel circuit (C) corresponding to the embodiments shown in FIGS. 6-8 refers to FIG. 1 and includes light-emitting control transistors, which can be a first light-emitting control transistor (M5) and a second light-emitting control transistor (M6). The light-emitting control transistors are electrically connected to the driving transistor (M0) and the light-emitting element (D) and are configured to control the driving current flowing through the light-emitting elements (D) during the light-emitting stage (TA). The light-emitting control transistors are also electrically connected to the light-emitting control signal lines, which transmit light-emitting control signals (Emit). The frequency of a light-emitting control signal (Emit) is higher than the basic operating frequency of the display panel.

In some embodiments, the second light-emitting stage (T2) is the light-emitting stage (TA) closest to the first light-emitting stage (T1) within the subframe where the second light-emitting stage (T2) is located, allowing for targeted compensation of brightness fluctuations during the data writing stage (Tdata).

Specifically, in embodiments shown in FIGS. 4 and 5, each subframe includes only one non-light-emitting stage (TB) and one light-emitting stage (TA). The light-emitting stage (TA) of the holding frame (Keep) adjacent to the data writing frame (Active), i.e., the second light-emitting stage (T2), can be considered the light-emitting stage (TA) closest to the first light-emitting stage (T1).

In one embodiment, as shown in FIG. 6, each subframe includes a plurality of non-light-emitting stages (TB) and a plurality of light-emitting stages (TA). Both the second light-emitting stage (T2) and the first light-emitting stage (T1) are located in the data writing frame (Active). The first light-emitting stage (T1) is a first light-emitting stage of the data writing frame (Active), while the second light-emitting stage (T2) is a second light-emitting stage of the data writing frame (Active). It can be understood that FIG. 6 illustrates an example where each subframe includes two non-light-emitting stages (TB) and two light-emitting stages (TA). In other embodiments, each subframe may include, for example, four non-light-emitting stages (TB) and four light-emitting stages (TA). The first light-emitting stage (T1) remains the first light-emitting stage of the data writing frame (Active), while the second light-emitting stage (T2) remains the second light-emitting stage of the data writing frame (Active).

In one embodiment, as shown in FIG. 7, each subframe includes a plurality of non-light-emitting stages (TB) and a plurality of light-emitting stages (TA). If the second light-emitting stage (T2) is in the holding frame (Keep) after the data writing frame (Active), where the first light-emitting stage (T1) is located, the second light-emitting stage (T2) serves as the first light-emitting stage in the holding frame (Keep).

In one embodiment, as shown in FIG. 8, each subframe includes a plurality of non-light-emitting stages (TB) and a plurality of light-emitting stages (TA). If the second light-emitting stage (T2) is in the holding frame (Keep) before the data writing frame (Active) of the first light-emitting stage (T1), then the second light-emitting stage (T2) serves as the last light-emitting stage in the holding frame (Keep).

Since the brightness perceived by a human eye accumulates over time, the closer the second light-emitting stage (T2) is to the first light-emitting stage (T1), the more directly any brightness adjustments to the second light-emitting stage (T2) can compensate for the first light-emitting stage (T1), enhancing an overall compensation effect for brightness fluctuations. In view of the above, in some embodiments, as shown in FIGS. 4 to 6 and 8, the second light-emitting stage (T2) and the first light-emitting stage (T1) are adjacent light-emitting stages (TA), further improving targeted compensation for brightness fluctuations during the data writing stage (Tdata).

For example, if additional light-emitting stage (TA) is arranged between the second light-emitting stage (T2) and the first light-emitting stage (T1), adjusting the brightness change produced by the second light-emitting stage (T2) will compensate for the brightness of the intermediate light-emitting stage (TA). Consequently, a brightness change of the intermediate light-emitting stage (TA) will compensate for the brightness of the first light-emitting stage T1, ultimately resulting in a poor compensation effect compared to the compensation effect of the above embodiment.

In some embodiments, as shown in FIG. 3, the display panel includes an edge pixel row (P0) in an edge area of the display area (AA). The display panel uses an edge algorithm for edge pixel rows (P0), that is, providing blackening data voltages to the edge pixel rows (P0) to make the brightness transition from the display area (AA) to the non-display area of the display panel more natural. After applying the edge algorithm, the data signal will jump high to (VGMP) at the end of the data writing stage (Tdata) and couple with the (N1) node of the pixel circuit (C), which is connected to a same data signal line (Data line), raising the potential of the (N1) node. Since the holding frame (Keep) does not write data, the coupling only occurs in the data writing frame (Active). The discontinuity in coupling causes the brightness of the light-emitting element (D) to drop after the data writing stage (Tdata), which ultimately results in a high brightness of the light-emitting element (D) in the data writing frame (Active), causing the display panel to flicker.

In view of the above, in some embodiments, the light-emitting duration of the second light-emitting stage (T2) is shorter than the light-emitting duration of the first light-emitting stage (T1), which reduces the brightness of the data writing frame (Active) or the keeping frame (Keep) adjacent to the data writing frame (Active) as perceived by a human eye, thereby compensating for the brightness fluctuation caused by the writing of the data signal to the pixel circuits and improving the display effect.

It should be noted that since the first light-emitting stage (T1) is a light-emitting stage immediately adjacent to the data writing stage (Tdata), the final required light-emitting brightness of the light-emitting element (D) is mainly reflected by the light-emitting duration of the first light-emitting stage (T1). Directly reducing the duration of the first light-emitting stage (T1) may lead to over-compensation, causing the light-emitting brightness of the light-emitting element (D) to fail to meet expectations. The same is true for the following embodiments, which will not be repeated herein.

Specifically, in the embodiment shown in FIG. 6, the second light-emitting stage (T2) and the first light-emitting stage (T1) are located in the same data writing frame (Active), and the second light-emitting stage (T2) is positioned after the first light-emitting stage (T1). The light-emitting duration of the second light-emitting stage (T2) is shorter than the light-emitting duration of the first light-emitting stage (T1), thereby reducing an overall light-emitting duration of the data writing frame (Active), decreasing the brightness of the data writing frame (Active) perceived by a human eye, compensating for brightness fluctuations caused by writing data signals to the pixel circuit, and improving the display effect.

In embodiments shown in FIGS. 5 and 8, the first light-emitting stage (T1) is located in the data writing frame (Active) of the i-th frame, and the second light-emitting stage (T2) is located in the holding frame (Keep) of the (i-1)-th frame, where i ≥ 2 and i is a positive integer. The light-emitting duration of the second light-emitting stage (T2) is shorter than the ighting duration of the first light-emitting stage (T1), thereby reducing the light-emitting duration of the holding frame (Keep) adjacent to the data writing frame (Active), decreasing the perceived brightness of the data writing frame (Active) to a human eye, compensating for brightness fluctuations caused by writing data signals to the pixel circuits, and improving the display effect.

In embodiments shown in FIG. 4 and FIG. 7, the second light-emitting stage (T2) is located in the holding frame (Keep) adjacent to the data writing frame (Active) where the first light-emitting stage (T1) is located, and the second light-emitting stage (T2) is located after the first light-emitting stage (T1). The light-emitting duration of the second light-emitting stage (T2) is shorter than the light-emitting duration of the first light-emitting stage (T1), thereby reducing the light-emitting duration of the holding frame (Keep) adjacent to the data writing frame (Active), decreasing the perceived brightness of the data writing frame (Active) to a human eye, compensating for brightness fluctuations caused by writing data signals to the pixel circuits, and improving the display effect. Specifically, in the embodiment shown in FIG. 7, the holding frame (Keep) includes at least two light-emitting stages (TA), and the second light-emitting stage (T2) is the first light-emitting stage (TA) in the holding frame (Keep).

Leakage current refers to a phenomenon in which a small amount of current flows through a source and drain of a transistor when the transistor should be in a turning-off state. AL-though leakage current is very small, the leakage current can affect the display effect. For example, if the leakage current persists, the brightness of a light-emitting element (D) will gradually decrease and fail to maintain an intended brightness. Additionally, the brightness of the light-emitting element (D) will spike when a next frame of data is written, causing flickering.

In low-temperature polycrystalline oxide (LTPO) display panels, aL-though low-temperature polysilicon (LTPS) transistors have an advantage of strong driving capabilities, the LTPS transistors also exhibit more severe leakage issues. The problem becomes especially noticeable when the display panel operates at low frequencies, as a gradual decrease in the brightness of a light-emitting element (D) due to leakage becomes more pronounced.

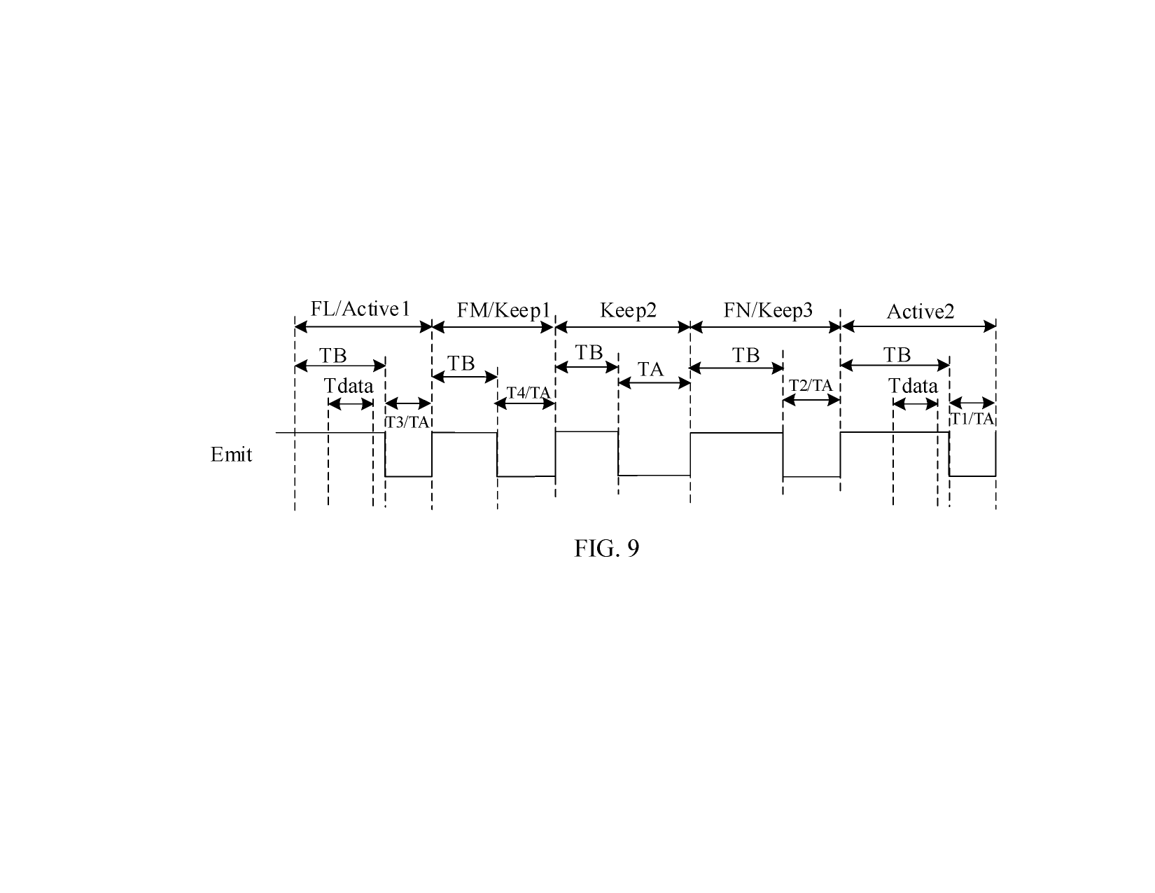

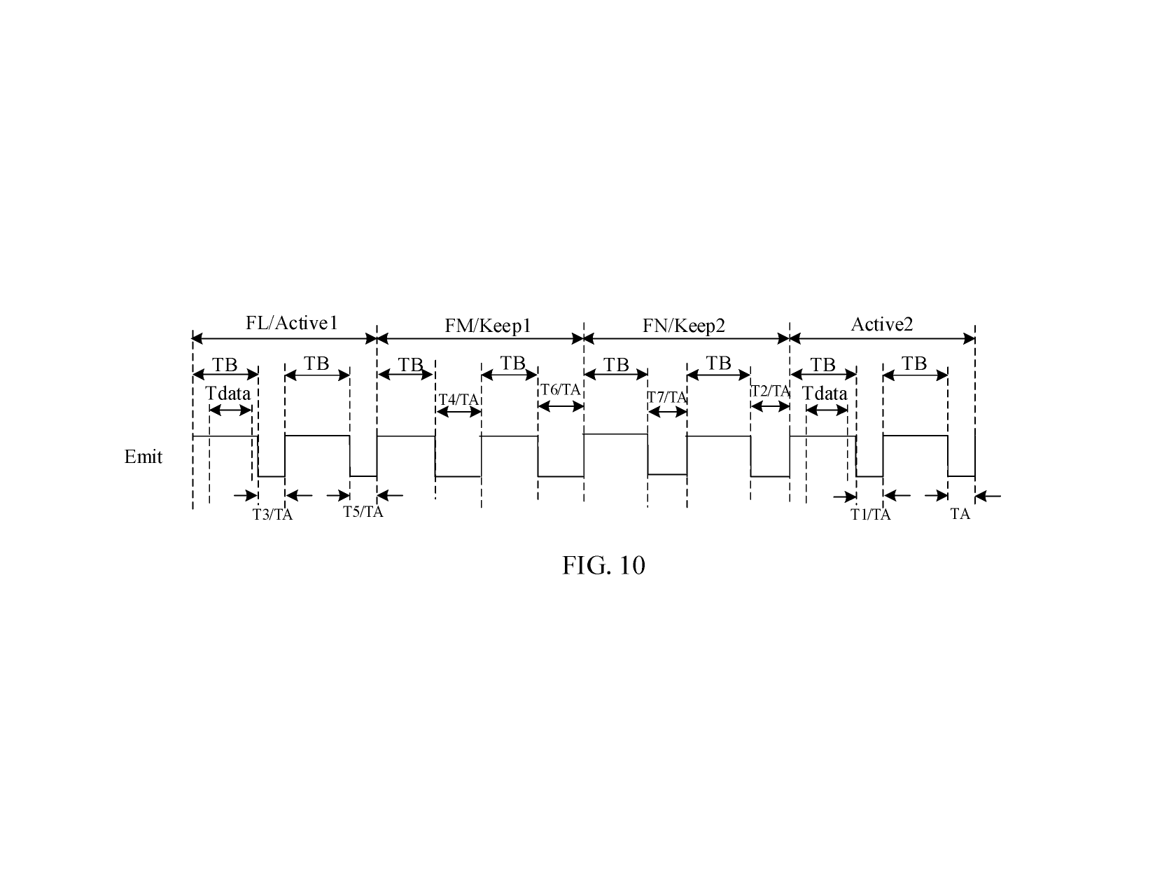

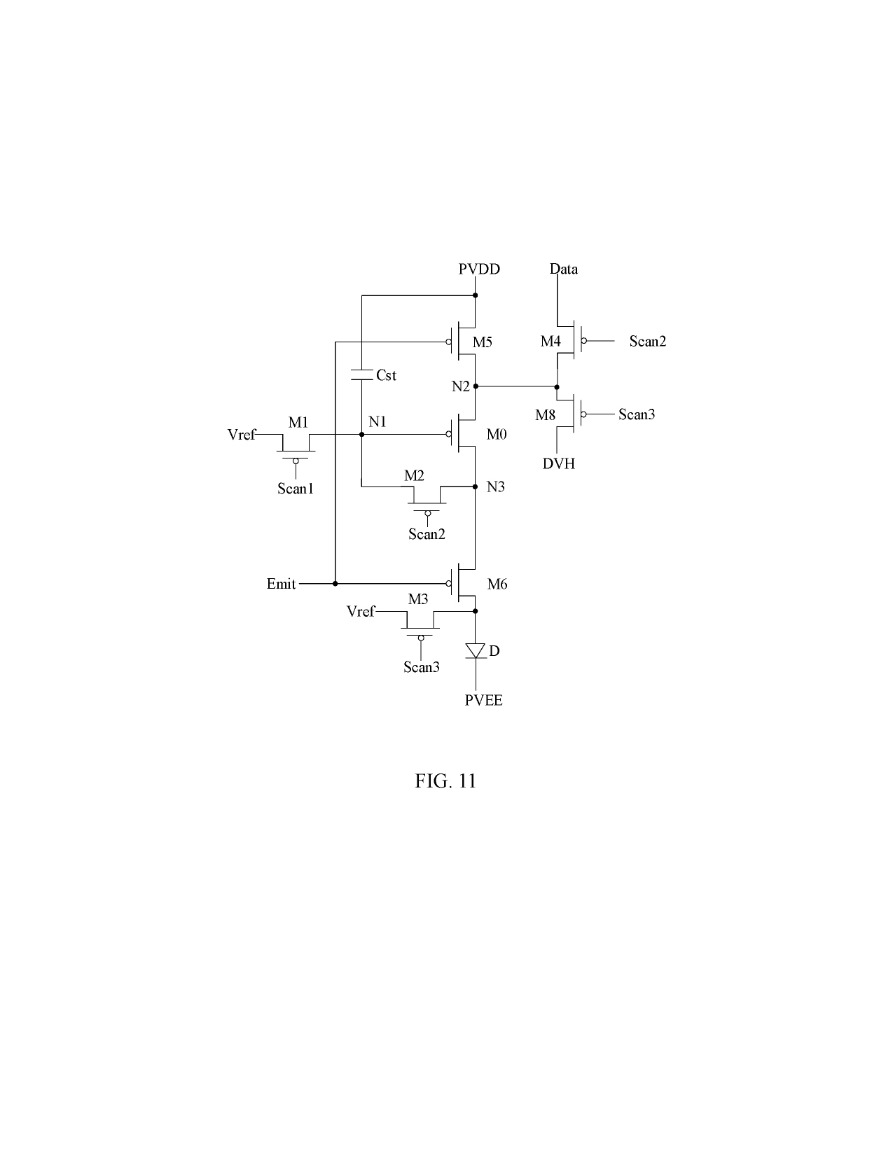

In view of the above, in some embodiments, as shown in FIGS. 9 and 10, the first light-emitting stage (T1) is located in a data writing frame (Active2) of the i-th frame, while the second light-emitting stage (T2) is located in the holding frame (Keep) of the (i-1)-th frame. Specifically, it is the holding frame (Keep) closest to the data writing frame (Active2) of the first light-emitting stage (T1), where i ≥ 2 and i is a positive integer.

Specifically, in one embodiment, as shown in FIG. 9, one frame includes one data writing frame and three holding frames. The second light-emitting stage (T2) is located in a last holding frame (Keep3) of the (i-1)-th frame, closest to the first light-emitting stage T1. In the embodiment shown in FIG. 9, one subframe only includes one light-emitting stage (TA). The second light-emitting stage (T2) is a light-emitting stage (TA) of the third holding frame (Keep3). In one embodiment, as shown in FIG. 10, one frame includes one data writing frame and two holding frames. The second light-emitting stage (T2) is located in the last holding frame (Keep2) of the (i-1)-th frame, closest to the first light-emitting stage (T1). In the embodiment, one subframe includes a plurality light-emitting stages (TA). The second light-emitting stage (T2) is the last light-emitting stage (TA) in the second holding frame (Keep2).

It should be understood that FIG. 9 and FIG. 10 are merely exemplary. In other embodiments, one frame may include a greater number of holding frames. A person skilled in the art can derive specific implementation methods based on the above embodiments of the present disclosure, which will not be repeated herein.

In embodiments shown in FIGS. 9 and 10, the (i-1)-th frame includes a L-th subframe (FL), an M-th subframe (FM), and an N-th subframe (FN), where L, M, and N are positive integers, with L ≥ 1, M > 1, and N > 1. The L-th subframe (FL) is located before the M-th subframe (FM), and the M-th subframe (FM) is located before the N-th subframe (FN). The L-th subframe (FL) serves as either a data writing frame (Active) or the holding frame (Keep), while both the M-th subframe (FM) and the N-th subframe (FN) are holding frames (Keep). The second light-emitting stage (T2) is in the N-th subframe (FN).

Specifically, in the embodiment shown in FIG. 9, the L-th subframe (FL) can be the data writing frame (Active1) of the (i-1)-th frame. The M-th subframe (FM) can be the first holding frame (Keep1) of the (i-1)-th frame, while the N-th subframe (FN) can be the third and last holding frame (Keep3) of the (i-1)-th frame. In another specific embodiment, the L-th subframe (FL) can also be the first holding frame (Keep1) of the (i-1)-th frame, and the M-th subframe (FM) can be the second holding frame (Keep2) of the (i-1)-th frame.

In the embodiment shown in FIG. 10, the L-th subframe (FL) can be the data writing frame (Active1) of the (i-1)-th frame, the M-th subframe (FM) can be the first holding frame (Keep1) of the (i-1)-th frame, and the N-th subframe (FN) can be the second and last holding frame (Keep2) of the (i-1)-th frame..

In the embodiment shown in FIG. 9 and FIG. 10, a total light-emitting duration of the L-th subframe (FL) is TLTL, a total light-emitting duration of the M-th subframe (FM) is TMTM, and a total light-emitting duration of the N-th subframe (FN) is TNTN, where TL<TMTL<TM and TM≥TNTM≥TN. Specifically, when a subframe includes multiple light-emitting stages (TA), a total light-emitting duration of the subframe is a sum of durations of all light-emitting stages (TA) in the subframe.

To address an issue of a gradual decrease in the brightness of the light-emitting element (D) caused by leakage current, the total light-emitting time (TMTM) of the M-th subframe (FM) is greater than the total light-emitting time (TLTL) of the L-th subframe (FL). In other words, by increasing the light-emitting time of the holding frame, the brightness of the light-emitting element (D) decreases in the holding frame. To prevent excessive brightness of the light-emitting element (D) in the data writing frame (Active), it is necessary to increase the light-emitting time of the holding frame while relatively reducing the light-emitting time of the last holding frame. That is, the total light-emitting time (TNTN) of the N-th subframe (FN) should be less than or equal to the total light-emitting time (TMTM) of the M-th subframe (FM).

In some other embodiments, the display panel includes a plurality of holding frames in one frame. Except for the last holding frame, a total light-emitting duration of the plurality of holding frames increases sequentially. A total light-emitting duration of the last holding frame is less than or equal to a total light-emitting duration of the penultimate holding frame.

In some embodiments, as shown in FIGS. 9 and 10, a total light-emitting duration of the data writing frame (Active2) of the i-th frame is less than a total light-emitting duration of the N-th subframe (FN). The light-emitting duration of the second light-emitting stage (T2) is longer than that of the first light-emitting stage (T1).

When display panel includes a plurality of holding frames in one frame, leakage causes the brightness of the light-emitting element to continuously decrease, having a greater impact than the high brightness of the data writing frame. Therefore, the light-emitting duration of the second light-emitting stage (T2) needs to be longer than the light-emitting duration of the first light-emitting stage (T1) to balance the brightness of the light-emitting element throughout the entire display process.

In some embodiments, as shown in FIG. 9, one subframe includes one light-emitting stage (TA). The L-th subframe (FL) includes the third light-emitting stage (T3), and the M-th subframe (FM) includes the fourth light-emitting stage (T4).

Specifically, in the embodiment shown in FIG. 9, the third light-emitting stage (T3) can be the light-emitting stage (TA) responsible for writing the data of the (i-1)-th frame to the data writing frame (Active1). The fourth light-emitting stage (T4) can be the light-emitting stage (TA) of the first holding frame (Keep1) of the (i-1)-th frame. In another specific embodiment, the third light-emitting stage (T3) may also be the light-emitting stage (TA) of the first holding frame (Keep1) of the (i-1)th frame, while the fourth light-emitting stage (T4) may be the light-emitting stage (TA) of the second holding frame (Keep2) of the (i-1)-th frame..

The light-emitting duration of the second light-emitting stage (T2) is less than or equal to the light-emitting duration of the fourth light-emitting stage (T4), and the light-emitting duration of the fourth light-emitting stage (T4) is greater than the light-emitting duration of the third light-emitting stage (T3).

When a subframe of the display panel includes only one light-emitting stage (TA), the light-emitting duration of the light-emitting stage (TA) is equivalent to the total light-emitting duration of the subframe. To address a gradual decrease in the brightness of the light-emitting element (D) caused by leakage current, the light-emitting duration of the fourth light-emitting stage (T4) is set longer than the light-emitting duration of the third light-emitting stage (T3). The increase in the light-emitting duration of the holding frame helps compensate for brightness reduction. To prevent excessive brightness in the data writing frame (Active), the light-emitting duration of the holding frame is increased while relatively reducing the light-emitting duration of the last holding frame. That is, the light-emitting duration of the second light-emitting stage (T2) is set to be less than or equal to the light-emitting duration of the fourth light-emitting stage (T4).

In some embodiments, as shown in FIG. 10, one subframe includes a plurality of light-emitting stages (TA).

The L-th subframe (FL) includes a third light-emitting stage (T3) and a fifth light-emitting stage (T5). The M-th subframe (FM) includes a fourth light-emitting stage (T4) and a sixth light-emitting stage (T6). The N-th subframe (FN) includes a seveN-th light-emitting stage (T7).

Specifically, in the embodiment shown in FIG. 10, the L-th subframe (FL) can be the data writing frame (Active1) for the (i-1)-th frame. The third light-emitting stage (T3) can be the first light-emitting stage (TA) of the data writing frame (Active1), while the fifth light-emitting stage (T5) can be the second light-emitting stage (TA) of the data writing frame (Active1). The M-th subframe (FM) may be the first holding frame (Keep1) of the i-1th frame. The fourth light-emitting stage (T4) may be the first light-emitting stage (TA) of the holding frame (Keep1), and the sixth light-emitting stage (T6) may be the second light-emitting stage (TA) of the holding frame (Keep1). The N-th subframe (FN) may be the second and last holding frame (Keep2) of the (i-1)-th frame. The seveN-th light-emitting stage (T7) may be the first light-emitting stage (TA) of the holding frame (Keep2). The seveN-th light-emitting stage (T7) is located before the second light-emitting stage (T2).

A total light-emitting duration of the third light-emitting stage (T3) and the fifth light-emitting stage (T5) is less than a total light-emitting duration of the fourth light-emitting stage (T4) and the sixth light-emitting stage (T6). Furthermore, a total light-emitting duration of the fourth light-emitting stage (T4) and the sixth light-emitting stage (T6) is greater than or equal to a total light-emitting duration of the second light-emitting stage (T2) and the seveN-th light-emitting stage (T7).

When a subframe of the display panel includes a plurality of light-emitting stages (TA), a total light-emitting duration of a subframe is the sum of the light-emitting durations of the plurality of light-emitting stages (TA). To address a gradual decrease in the brightness of the light-emitting element (D) due to leakage, the total light-emitting duration of the fourth light-emitting stage (T4) and the sixth light-emitting stage (T6) is set longer than the total light-emitting duration of the third light-emitting stage (T3) and the fifth light-emitting stage (T5). That is, by increasing the lighting duration of the holding frame, the brightness of the light-emitting element D decreases in the holding frame. To prevent excessive brightness in the data writing frame (Active), it is necessary to extend the light-emitting duration of the holding frame while relatively reducing the light-emitting duration of the last holding frame. That is, a total light-emitting duration of the second light-emitting stage (T2) and the seveN-th light-emitting stage (T7) is less than or equal to a total light-emitting duration of the fourth light-emitting stage (T4) and the sixth light-emitting stage (T6).

In the embodiment shown in FIG. 10, the fifth light-emitting stage (T5) occurs after the third light-emitting stage (T3), the sixth light-emitting stage (T6) occurs after the fourth light-emitting stage (T4), and the second light-emitting stage (T2) occurs after the seveN-th light-emitting stage (T7).

The light-emitting duration of the fifth light-emitting stage (T5) is greater than or equal to the light-emitting duration of the third light-emitting stage (T3). The light-emitting duration of the sixth light-emitting stage (T6) is greater than or equal to the light-emitting duration of the fourth light-emitting stage (T4). The light-emitting duration of the second light-emitting stage (T2) is shorter than that of the seveN-th light-emitting stage (T7).

When a sub-frame of the display panel includes a plurality of light-emitting stages (TA), the light-emitting duration of these stages can be gradually increased to further compensate for brightness reduction caused by leakage current. However, to prevent excessive brightness in the data writing frame (Active), the light-emitting duration of the last light-emitting stage in the final holding frame of a frame (i.e., the second light-emitting stage (T2)) must be shorter than the light-emitting duration of the preceding light-emitting stage (i.e., the seveN-th light-emitting stage (T7)).

In other embodiments, the N-th subframe includes the second light-emitting stage (T2) and the seveN-th light-emitting stage (T7), with the second light-emitting stage (T2) occurring after the seveN-th light-emitting stage (T7). The light-emitting duration of the second light-emitting stage (T2) is shorter than that of the seveN-th light-emitting stage (T7). A total light-emitting duration (T_{N}) of the N-th subframe may be equal to the total light-emitting duration (T_{M}) of the M-th subframe. That is, the total light-emitting duration of the fourth (T4) and sixth (T6) light-emitting stages is equal to the total light-emitting duration of the second (T2) and seveN-th (T7) light-emitting stages.

In other embodiments, the leakage problem of the display panel is smaller, and one frame includes a plurality of holding frames (including the L-th subframe, M-th subframe, and N-th subframe). A holding frame includes a plurality of light-emitting stages. The N-th subframe includes a second light-emitting stage (T2) and a seveN-th light-emitting stage (T7). The second light-emitting stage (T2) occurs after the seveN-th light-emitting stage (T7). The light-emitting duration of the second light-emitting stage (T2) is shorter than the light-emitting duration of the seveN-th light-emitting stage (T7). The total light-emitting duration of the L-th subframe is (T_{L}), the total light-emitting duration of the M-the subframe is (T_{M}), and the total light-emitting duration of the N-th subframe is (T_{N}), where T_{L}=T_{M}=T_{N}, that is, the total light-emitting duration of the third light-emitting stage (T3) and the fifth light-emitting stage (T5) is equal to the total lighting time of the fourth light-emitting stage (T4) and the sixth light-emitting stage (T6.) The total lighting time of the fourth light-emitting stage (T4) and the sixth light-emitting stage (T6) is equal to the total lighting time of the second light-emitting stage (T2) and the seveN-th light-emitting stage (T7).

In one embodiment, the light-emitting duration of the second light-emitting stage (T2) is shorter than the light-emitting duration of the first light-emitting stage (T1). Specifically, (T2) is reduced by at least 2H and at most 16H compared to (T1), where H represents a duration required for the display panel to scan a single pixel row, also known as a horizontal frequency or horizontal period.

A period required for the display panel to scan a pixel row refers to a period needed to update display content row by row, also known as a row scanning time. During the period, the data signals of all pixels in a row are refreshed. The same definition applies to the following embodiments and will not be repeated herein.

In embodiments where the light-emitting duration of the second light-emitting stage (T2) is shorter than the light-emitting duration of the fourth light-emitting stage (T4), the light-emitting duration of the second light-emitting stage (T2) is reduced by at least 2H compared to the fourth light-emitting stage (T4). The reduction can be at most 16H. H represents a period required for the display panel to scan one pixel row.

A schematic diagram of a pixel circuit consistent with various embodiments of the present disclosure is illustrated in FIG. 1, and a corresponding working stage timing diagram is illustrated in FIG. 2. As shown in the figures, the pixel circuit also includes an anode reset transistor (M3). The control electrode of the anode reset transistor (M3), and the control electrode of the data writing transistor (M4) are connected to a same signal line and jointly receive a third scan signal (Scan3). The anode reset transistor (M3) is configured to provide an anode reset signal (Vref) to a light-emitting element (D) during the data writing stage (Tdata).

FIG. 2 only marks the non-light-emitting period (TB) and the light-emitting period (TA) in the working stage of the display panel. Based on the embodiments shown in FIGS. 4-10, those skilled in the art can substitute the light-emitting stages in the first light-emitting stage (T1), the second light-emitting stage (T2), and other light-emitting stages from different embodiments, into the embodiment shown in FIG. 2 to obtain a complete display panel working stage timing diagram, which falls within the protection scope of the present disclosure..

As shown in FIG. 2, at least part of the non-light-emitting stage (TB) includes a bias stage (Tp). The bias stage (Tp) is located in the holding frame (Keep) and precedes the light-emitting stage (TA). The data writing stage (Tdata) is only present in the data writing frame (Active).

The anode reset transistor (M3) also provides an anode reset signal (Vref) to the light-emitting element (D) during a bias stage (Tp), while the data writing transistor (M4) provides a bias signal to the driving transistor (M0) during the bias stage (Tp).

Specifically, the display panel does not write data during the holding frame (Keep). AL-though the data writing transistor (M4) is turned on during the bias stage (Tp), the data writing transistor (M4) is only used for bias adjustment of the node (N2) in the circuit.

As shown in FIGS. 1 and 2, the pixel circuit also includes a gate reset transistor (M1), a threshold compensation transistor (M2), and a light-emission control transistor, which specifically includes a first light-emission control transistor (M5) and a second light-emission control transistor (M6).

At least part of the non-light-emitting stage (TB) of the data writing frame (Active) also includes a gate reset stage (Tref) and a threshold compensation stage (Tth). Specifically, as shown in FIG. 2, the threshold compensation stage (Tth) coincides with the data writing stage (Tdata).

The control electrode of the gate reset transistor M1 receives the first scan signal Scan1 and is used to provide the gate reset signal Vref to the driving transistor M0 during the gate reset stage Tref.

A control electrode of the gate reset transistor (M1) receives a first scan signal (Scan1) and is used to provide a gate reset signal (Vref) to the driving transistor (M0) during the gate reset stage (Tref).

A control electrode of a light-emitting control transistor receives an emission signal (Emit) and controls the light-emitting current flowing through a light-emitting element (D) during the light-emitting stage (TA).

During implementation, as shown in FIG. 1, a pixel circuit also includes a storage capacitor (Cst), which is electrically connected between the power signal line (PVDD) and the gate of the driving transistor (M0).

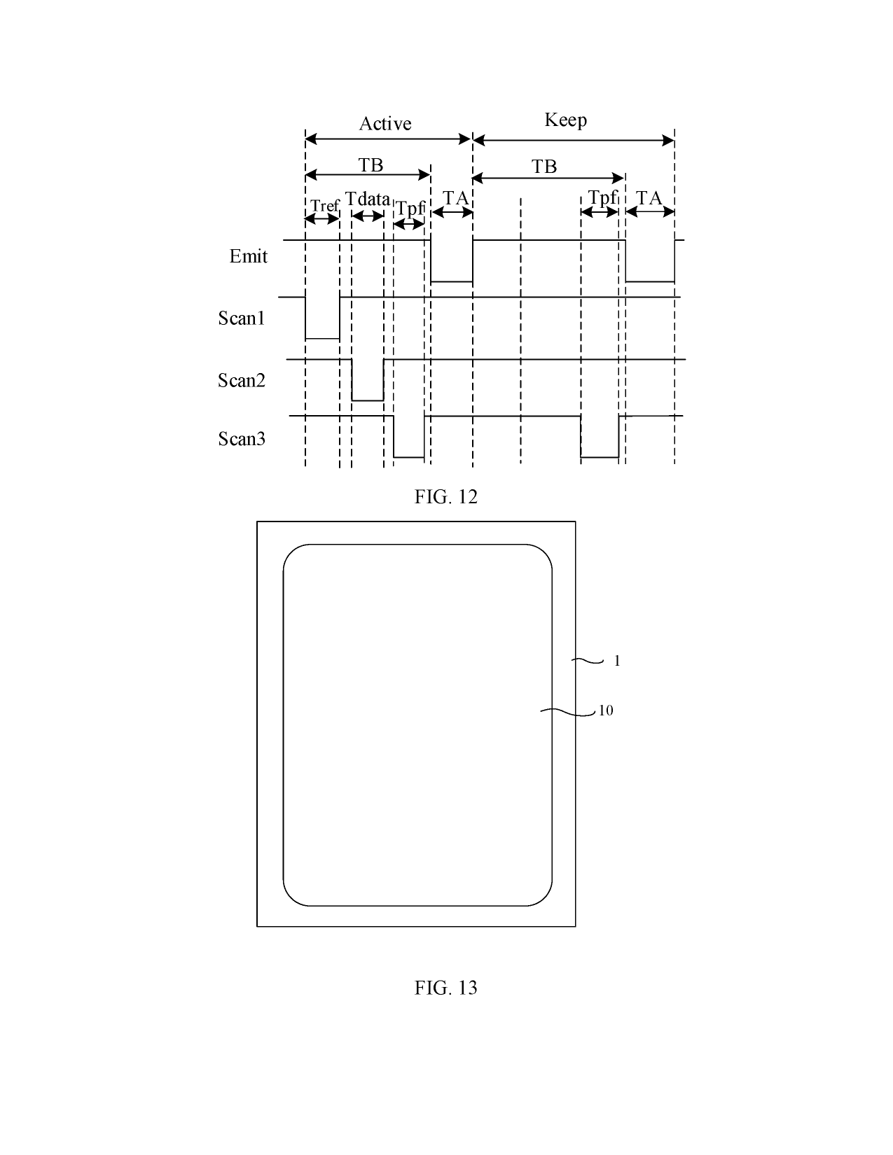

A schematic diagram of another pixel circuit consistent with various embodiments of the present disclosure is illustrated in FIG. 11, with a corresponding driving timing diagram illustrated in FIG. 12. The pixel circuit also includes an anode reset transistor (M3) and a bias transistor (M8). A control electrode of the bias transistor (M8) and the anode reset transistor (M3) are connected to a same signal line and jointly receive a third scan signal (Scan3).

At least part of the non-light-emitting stage (TB) includes an anode reset and bias stage (Tpf). The bias transistor (M8) provides a bias signal (DVH) to the driving transistor (M0) during the anode reset and bias stage (Tpf). The anode reset transistor (M3) provides an anode reset signal (Vref) to a light-emitting element (D) during the anode reset and bias stage (Tpf). Specifically, the anode reset and bias stage (Tpf) occurs after the data writing stage (Tdata).

FIG. 12 marks only the non-light-emitting period (TB) and the light-emitting period (TA) in the working stages of the display panel. Based on the embodiments illustrated in FIGS. 4-10, a person skilled in the art can substitute the light-emitting stages from the first light-emitting stage (T1), the second light-emitting stage (T2), and other light-emitting stages from different embodiments, into the embodiment shown in FIG. 12 to obtain a complete display panel working stage timing diagram, which falls within the protection scope of the present disclosure.

In some embodiments, as shown in FIG. 12, both the data writing frame (Active) and the holding frame (Keep) include the anode reset and bias stage (Tpf), which is used to reset an anode of a light-emitting element D in the holding frame (Keep) and perform bias adjustment for the node (N2) in the circuit. The data writing stage (Tdata) is only located in the data writing frame (Active).

As shown in FIGS. 11 and 12, the pixel circuit also includes a gate reset transistor (M1), a threshold compensation transistor (M2), and a light-emission control transistor, which specifically includes a first light-emission control transistor (M5) and a second light-emission control transistor (M6).

At least part of the non-light-emitting stage (TB) of the data writing frame (Active) also includes a gate reset stage (Tref). The gate reset stage (Tref) is located before the data writing stage (Tdata).

A control electrode of the gate reset transistor (M1) receives a first scan signal (Scan1) and provides a gate reset signal (Vref) to the driving transistor (M0) during the gate reset stage (Tref).

A control electrode of the threshold compensation transistor (M2) receives a second scan signal (Scan2) and compensates for a threshold voltage of the driving transistor (M0) during the data writing stage (Tdata).

A control electrode of a light-emitting control transistor receives an emission signal (Emit) and controls a light-emitting current flowing through a light-emitting element (D) during the light-emitting stage (TA).

Based on the same inventive concept, the present disclosure also provides a display device corresponding to the display panel in any of the above embodiments. As shown in FIG. 13, the display device (1) includes the display panel (10) as described in any of the above embodiments.

The display panel in the display device provided by this embodiment adjusts the brightness of the light-emitting element in the data writing frame (Active) by modifying the light-emitting duration thereof. Alternatively, by adjusting the light-emitting duration in the holding frame (Keep) before and after the data writing frame (Active), the brightness of a light-emitting element in the data writing frame (Active) is compensated. The compensation mitigates brightness fluctuations caused by writing a data signal to a pixel circuit, thereby enhancing the display effect.

Specifically, the display device can be a computer and peripherals of the computer, as well as communication and consumer electronics (3C products), such as a smartphone, laptop, tablet, smart wearable device, home appliance, or gaming device. Additionally, the display device can also be applied to other types of electronic devices, including automotive electronics.

As disclosed, the display panel and the display device provided by the present disclosure at least realize the following beneficial effects.

The display panel provided by the present disclosure adjusts the brightness of a light-emitting element in the data writing frame by changing the lighting time of the light-emitting element in the data writing frame. Alternatively, by changing the light-emitting duration of the light-emitting element in the holding frame before and after the data writing frame, compensates for the brightness of the light-emitting element in the data writing frame, thereby compensating for brightness fluctuations caused by writing the data signal to the pixel circuit, and improving the display effect.

It should be noted that in the present specification, relationship terms such as "first" and "second" are merely used to distinguish one entity or operation from another, and do not necessarily require or imply that any actual relationship or sequence exists between these entities or operations. Moreover, the terms "include", "comprise", or their any other variants are intended to cover a non-exclusive inclusion, so that a process, a method, an article, or a terminal device that includes a list of elements not only includes those elements but also includes other elements that are not listed, or further includes elements inherent to such a process, method, article, or terminal device. Without being subject to further limitations, an element defined by a phrase "including a......." does not exclude the presence of other identical elements in the process, method, article, or terminal device that includes the very element.

The above are only specific embodiments of the present disclosure, enabling those skilled in the art to understand or implement the present disclosure. Various modifications to the examples described herein will be readily apparent to those of ordinary skill in the art, and the general principles defined herein may be applied to other examples and applications without departing from the spirit and scope of the various embodiments. Therefore, the present disclosure is not intended to be limited to the embodiments described herein but is to be accorded the broadest scope consistent with principles and novel features disclosed herein.

What is claimed is:

1. A display panel, wherein:
working stages of the display panel include a plurality of non-light-emitting stages and a plurality of light-emitting stages, at least part of a non-light-emitting stage of the plurality of non-light-emitting stages includes a data writing stage;
the display panel includes a plurality of sub-pixels, a sub-pixel of the plurality of sub-pixels includes a pixel circuit and a light-emitting element electrically connected to the pixel circuit, the light-emitting element emits light during a light-emitting stage, the pixel circuit includes a driving transistor and a data writing transistor, the data writing transistor provides a data signal to the driving transistor during the data writing stage;
in the display panel, a display process of one frame includes a plurality of subframes including a data writing frame and at least one holding frame;
the light-emitting stage includes a first light-emitting stage in the data writing frame, a non-light-emitting stage adjacent to the first light-emitting stage and located before the first light-emitting stage includes the data writing stage;
the light-emitting stage further includes at least one second light-emitting stage, a second light-emitting stage of the at least one second light-emitting stage being located in the data writing frame in which the first light-emitting stage is located and/or in a holding frame of the at least one holding frame adjacent to the data writing frame in which the first light-emitting stage is located; and
a light-emitting duration of the first light-emitting stage is different from a light-emitting duration of the second light-emitting stage.

2. The display panel according to claim 1, wherein the second light-emitting stage is a light-emitting stage closest to the first light-emitting stage in a subframe where the second light-emitting stage is located.

3. The display panel according to claim 2, wherein the second light-emitting stage and the first light-emitting stage are adjacent light-emitting stages.

4. The display panel according to claim 3, wherein
the second light-emitting stage and the first light-emitting stage are in a same data writing frame, the second light-emitting stage is located after the first light-emitting stage; and
the light-emitting duration of the second light-emitting stage is less than the light-emitting duration of the first light-emitting stage.

5. The display panel according to claim 3, wherein:
the first light-emitting stage is in the data writing frame of an i-th frame, while the second light-emitting stage is in the holding frame of an (i-1)-th frame, where i is a positive integer and i ≥ 2.; and
the light-emitting duration of the second light-emitting stage is less than the light-emitting duration of the first light-emitting stage.

6. The display panel according to claim 3, wherein:
the first light-emitting stage is located in the data writing frame of an i-th frame, and the second light-emitting stage is located in the holding frame of an (i-1)-th frame, where i is a positive integer and i ≥ 2;
the (i-1)-th frame includes the L-th subframe, the M-th subframe, and the N-th subframe, where L, M, and N are positive integers with L ≥ 1, M > 1, and N > 1, the L-th subframe is located before the M-th subframe, the M-th subframe is located before the N-th subframe, the L-th subframe is either a data writing frame or a holding frame, both the M-th and N-th subframes are holding frames and the second light-emitting stage is located in the N-th subframe;
a total light-emitting duration of the L-th subframe is T_{L,} a total light-emitting duration of the M-th subframe is T_{M,} and a total light-emitting duration of the N-th subframe is T_{N}; and
T_{L}<T_{M} and T_{M}≥T_{N}.

7. The display panel according to claim 6, wherein:
a total light-emitting duration of the data writing frame of an i-th frame is less than the total light-emitting duration of the N-th subframe; and
the light-emitting duration of the second light-emitting stage is longer than the light-emitting duration of the first light-emitting stage.

8. The display panel according to claim 6, wherein:
a subframe of the plurality of subframes includes a light-emitting stage, the L-th subframe includes a third light-emitting stage, and the M-th subframe includes a fourth light-emitting stage; and
the light-emitting duration of the second light-emitting stage is less than or equal to a light-emitting duration of the fourth light-emitting stage, and the light-emitting duration of the fourth light-emitting stage is greater than a light-emitting duration of the third light-emitting stage.

9. The display panel according to claim 6, wherein:
a subframe of the plurality of subframes includes a plurality of light-emitting stages;
the L-th subframe includes a third light-emitting stage and a fifth light-emitting stage, the M-th subframe includes a fourth light-emitting stage and a sixth light-emitting stage, the N-th subframe also includes a seventh light-emitting stage; and
a total light-emitting duration of the third light-emitting stage and the fifth light-emitting stage is less than a total light-emitting duration of the fourth light-emitting stage and the sixth light-emitting stage, the total light-emitting duration of the fourth light-emitting stage and the sixth light-emitting stage is greater than or equal to a total light-emitting duration of the second light-emitting stage and the seventh light-emitting stage.

10. The display panel according to claim 9, wherein:
the fifth light-emitting stage is located after the third light-emitting stage, the sixth light-emitting stage is located after the fourth light-emitting stage, and the second light-emitting stage is located after the seventh light-emitting stage; and
a light-emitting duration of the fifth light-emitting stage is greater than or equal to the light-emitting duration of the third light-emitting stage, a light-emitting duration of the sixth light-emitting stage is greater than or equal to a light-emitting duration of the fourth light-emitting stage, and the light-emitting duration of the second light-emitting stage is less than a light-emitting duration of the seventh light-emitting stage.

11. The display panel according to claim 2, wherein:
the second light-emitting stage is in the holding frame adjacent to a data writing frame in which the first light-emitting stage is located, and the second light-emitting stage is located after the first light-emitting stage; and
the light-emitting duration of the second light-emitting stage is less than the light-emitting duration of the first light-emitting stage.

12. The display panel according to claim 11, wherein the holding frame includes at least two light-emitting stages, and the second light-emitting stage is a first light-emitting stage in the holding frame.

13. The display panel according to claim 4, wherein the light-emitting duration of the second light-emitting stage is reduced by at least 2H and at most 16H compared with the light-emitting duration of the first light-emitting stage, where H represents a duration required for the display panel to scan one pixel row.

14. The display panel according to claim 8, wherein the light-emitting duration of the second light-emitting stage is reduced by at least 2H and at most 16H compared with the light-emitting duration of the fourth light-emitting stage, where H represents a duration required for the display panel to scan one pixel row.

15. The display panel according to claim 1, wherein:
the pixel circuit also includes a light-emitting control transistor, which is electrically connected to the driving transistor and a light-emitting element, the light-emitting element is configured to control a driving current to flow through the light-emitting element during the light-emitting stage; and
the light-emitting control transistor is electrically connected to a light-emitting control signal line, which transmits a light-emitting control signal, a changing frequency of the light-emitting control signal is greater than a basic operating frequency of the display panel.

16. The display panel according to claim 1, wherein the pixel circuit also includes an anode reset transistor, a control electrode of the anode reset transistor and a control electrode of the data writing transistor are connected to a same signal line, the anode reset transistor provides an anode reset signal to the light-emitting element during the data writing stage.

17. The display panel according to claim 16, wherein:
at least part of the non-light-emitting stage also includes a bias stage, and the holding frame includes the bias stage; and
the anode reset transistor provides an anode reset signal to the light emitting element during the bias stage, and the data write transistor also provides a bias signal to the driving transistor during the bias stage.

18. The display panel according to claim 16, wherein:
the pixel circuit also includes a gate reset transistor, a threshold compensation transistor, and a light-emission control transistor;
at least part of the non-light-emitting stage of the data writing frame further includes a gate reset stage and a threshold compensation stage;
the gate reset transistor provides a gate reset signal to the drive transistor during the gate reset stage;
the threshold compensation transistor compensates a threshold voltage of the driving transistor during the threshold compensation stage; and
the light-emitting control transistor controls the light-emitting current to flow through the light-emitting element during the light-emitting stage.

19. The display panel according to claim 1, wherein:
the pixel circuit further includes an anode reset transistor and a bias transistor, a control electrode of the bias transistor and a control electrode of the anode reset transistor are connected to a same signal line; and
at least part of the non-light-emitting stage also includes an anode reset and bias stage, the bias transistor provides a bias signal to the driving transistor during the anode reset and bias stage, and the anode reset transistor provides an anode reset signal to the light-emitting element during the anode reset and bias stage.

20. A display device comprising a display panel, wherein:
working stages of the display panel include a plurality of non-light-emitting stages and a plurality of light-emitting stages, at least part of a non-light-emitting stage of the plurality of non-light-emitting stages includes a data writing stage;
the display panel includes a plurality of sub-pixels, a sub-pixel of the plurality of sub-pixels includes a pixel circuit and a light-emitting element electrically connected to the pixel circuit, the light-emitting element emits light during a light-emitting stage, the pixel circuit includes a driving transistor and a data writing transistor, the data writing transistor provides a data signal to the driving transistor during the data writing stage;
in the display panel, a display process of one frame includes a plurality of subframes including a data writing frame and at least one holding frame;
the light-emitting stage includes a first light-emitting stage in the data writing frame, a non-light-emitting stage adjacent to the first light-emitting stage and located before the first light-emitting stage includes the data writing stage;
the light-emitting stage further includes at least one second light-emitting stage, a second light-emitting stage of the at least one second light-emitting stage being located in the data writing frame in which the first light-emitting stage is located and/or in a holding frame of the at least one holding frame adjacent to the data writing frame in which the first light-emitting stage is located; and
a light-emitting duration of the first light-emitting stage is different from a light-emitting duration of the second light-emitting stage.
